(19) United States
(12) Patent Application Publication
(10) Pub. No.: US 2024/0417034 A1
(43) Pub. Date: Dec. 19, 2024

(54) A METHOD FOR PROVIDING A HULL OF A VESSEL WITH BUBBLE GENERATORS

(71) Applicant: Alfa Laval Rotterdam B.V., ROTTERDAM (NL)

(72) Inventor: Pieter Karel Anton KAPTEIJN, Hilversum (NL)

(73) Assignee: Alfa Laval Rotterdam B.V., ROTTERDAM (NL)

(21) Appl. No.: 18/728,236

(22) PCT Filed: Feb. 2, 2023
(86) PCT No.: PCT/NL2023/050047

§ 371 Date: Jul. 11, 2024

(30) Foreign Application Priority Data
Feb. 9, 2022 (NL) 2030857

(51) Int. Cl. B63B 1/38

(52) U.S. Cl. CPC B63B 1/38

(57) ABSTRACT

A method for providing a hull of a vessel with bubble generators for reducing the drag of the hull includes providing at least one elongated slot in the hull, the slot having a length extending in a lateral direction of the vessel and a width extending perpendicular thereto; providing a multitude of bubble generator units, each having an inlet opening for supplying air and a bottom surface with at least one outlet opening for discharging air bubbles; and mounting the multitude of bubble generator units in the slot in a side by side manner along the length of the slot such that the slot is filled and substantially closed off by the bubble generator units, and such that the inlet openings of the bubble generator units face the interior of the hull and the bottom surfaces with the outlet openings of the bubble generator units face the exterior of the hull.

The present invention relates to a method for providing a hull of a vessel with bubble generators for reducing the drag of the hull.

Such a vessel is described in EP-A-0903287, wherein a ship achieves friction reduction effects by blowing out gas as micro-bubbles from gas jet outlets which are formed in the hull of the ship.

The vessel may for instance be a floating vessel, such as a ship, or a submarine. Air Lubrication (AL) is a known and proven way to reduce the friction experienced by ships moving through water, by injecting air under the bottom of the ship. The physical principle that leads to lower friction is assumed to be either a reduction of water dynamic viscosity caused by the two-phase mixture of bubbles and water, combined with the suppression of turbulence and momentum exchange in the boundary layer between ship skin and the water flowing around the ship. Existing Air Lubrication concepts rely on a series of orifices or air injection ‘chests’ placed at the bow of the ship that allow injection of air that, interacting with the flowing water, produces a sheet of bubbles or a homogeneous air layer, or a combination of both.

EP-A-2585364 describes a method in which a series of bands is retrofitted to the outside of the ship's hull. These bands are fitted with so-called fluidic oscillators, that generate and distribute streams of bubbles in a controlled way. The oscillation frequency may be used to control the bubble size produced by these devices.

The current invention seeks to extend and enhance the above concepts, for instance by allowing the oscillators described in EP-A-2585364 to be built into the skin of a new build ship as part of the shipbuilding process, allowing further enhancement of the drag reduction and/or by allowing easy installation, operation, maintenance, repair and/or replacement of the bubble generating system.

To this end, a method according to the preamble is characterized in that said method comprises the following steps:
providing at least one elongated slot in the hull, said slot having a length extending in a lateral direction of the vessel and a width extending perpendicular thereto;
providing a multitude of bubble generator units, each having an inlet opening for supplying air and a bottom surface with at least one outlet opening for discharging air bubbles; and
mounting said multitude of bubble generator units in said slot in a side by side manner along the length of said slot such that said slot is filled and substantially closed off by said bubble generator units, and such that said inlet openings of said bubble generator units face the interior of the hull and the bottom surfaces with the outlet openings of said bubble generator units face the exterior of the hull.

The elongated slots with the arrays of bubble generator units can be placed in the most effective areas of the ship's hull, to maximise the air lubrication effectiveness. Said lateral direction preferably is the direction which is substantially perpendicular to the local direction of the water flow along the surfacec of the hull when the vessel is moving in its intended normal forward direction. The placement can be based on CFD simulations and practical experience.

The system can be fitted once the ship construction phase has been completed.

The method avoids damaging the bubble generator units, and also allows easy replacement and upgrading of the oscillators units at regular dry-docking/inspection of the ship.

According to a preferred embodiment, the bubble generator units are mounted in said slots by means of mounting means, said mounting means being fixed to the longitudinal edges of said slot along the entire length thereof, and wherein said bubble generator units are mounted to said mounting means in a releasable manner.

The mounting means may be welded or glued or bolted to the hull, and allow for easy maintenance, repair and replacement of the units.

According to a preferred embodiment, said mounting means comprise at least one mounting block, each mounting block comprising a base plate which is arranged to cover the width of the slot, and a first end wall and a second end wall which extend from the outer lateral ends of the base plate, wherein the end walls are fixed to the lateral edges of the slot, said at least one mounting block forming a substantially U-shaped channel in said slot in which the bubble generator units are mounted, such that the bottom surface of the bubble generator units are substantially flush with the exterior surface of the hull.

Thereby the protrusion of (retrofitted) bands is taken away, further reducing the drag of the system and ensuring that the system components are not damaged in case of accidental grounding of the ship or a collision with floating objects.

According to a preferred embodiment, the interior surface of said base plate of said mounting block extends in a plane which is at a distance from the interior surface of the hull in the interior direction thereof.

According to a preferred embodiment, the mounting means are provided with inlet channels corresponding and in communication with one of each inlet opening of the bubble generator units.

According to a preferred embodiment, the inlet openings of the bubble generator units are formed by inlet tube ends which extend at a lateral side of the bubble generator units, and which inlet tube ends are inserted in openings of the inlet channels which extend in corresponding side walls of the mounting blocks.

According to a preferred embodiment, the bubble generator units are provided with a stepped or sloping protrusion at one side, and said mounting means comprise locking elements which are arranged to engage the protrusion, and which is provided with fixation means, such as screws, for fixing the locking elements to the base plate.

According to a preferred embodiment, providing an air channel in the interior of said hull to each of said inlet openings for providing air to each of said bubble generator units.

According to a preferred embodiment, said air channel is connected to a source of pressurised air.

According to a preferred embodiment, said air channel is formed by a bent wall which covers the interior side of the slot and the bubble generator units therein, and wherein the lateral edges of the bent wall are connected to the interior surface of the hull.

The bent wall may be welded, glued or bolted to the interior of the hull. Said air channel may also form a space plenum for accomodating wiring for sensors in or near said bubble generator units.

According to a preferred embodiment, the height of the bubble generator units is substantially smaller than the width of the slot.

According to a preferred embodiment, the bubble generator units are fluidic oscillators for generating one or more pulsating air flows from a constant air flow.

Finally, the present invention relates to a vessel with a hull provided with bubble generators for reducing the drag of the hull, wherein
the hull is provided with at least one elongated slot, said slot having a length extending in a lateral direction of the vessel and a width extending perpendicular thereto;
wherein a multitude of bubble generator units is provided, each having an inlet opening for supplying air and a bottom surface with at least one outlet opening for discharging air bubbles; and
wherein said multitude of bubble generator units is provided in said slot in a side by side manner along the length of said slot such that said slot is filled and substantially closed off by said bubble generator units, and such that said inlet openings of said bubble generator units face the interior of the hull and the bottom surfaces with the outlet openings of said bubble generator units face the exterior of the hull.

According to a preferred embodiment, the vessel is a self propelled ship or a vessel which is to be towed by another vessel.

The present invention will now be illustrated with reference to the drawing where

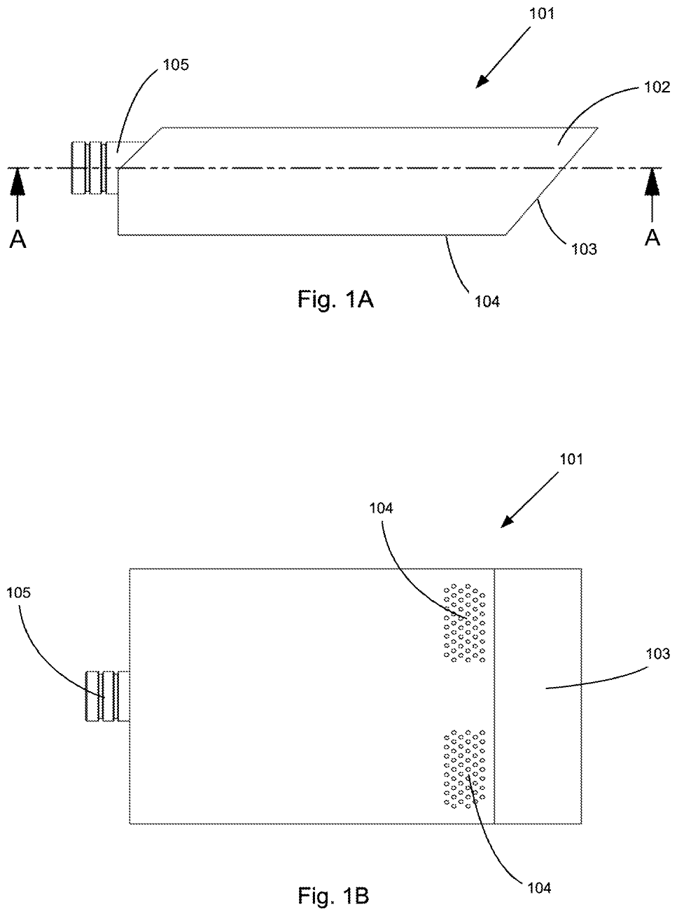

FIG. 1A shows a side view of an oscillator;

FIG. 1B shows a bottom view of the oscillator of FIG. 1A;

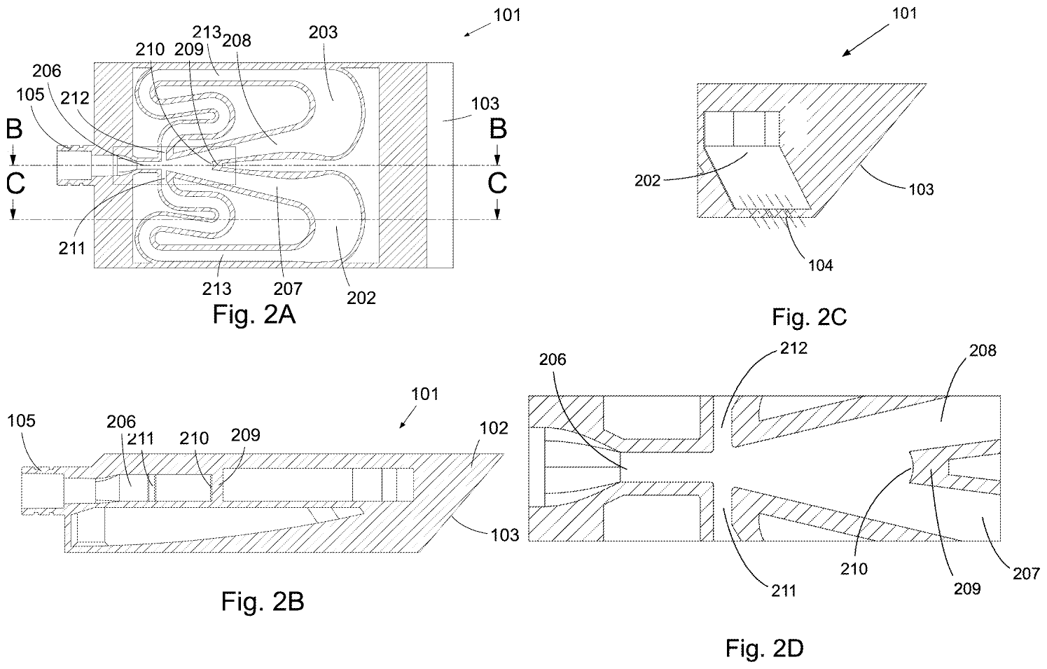

FIG. 2A shows a cross-section of the oscillator of FIG. 1A according to line A-A;

FIG. 2B shows a cross-section of the oscillator of FIG. 1A according to line B-B;

FIG. 2C shows a partial cross-section of the oscillator of FIG. 1A according to line C-C;

FIG. 2D shows a detail of the cross-section of FIG. 2A;

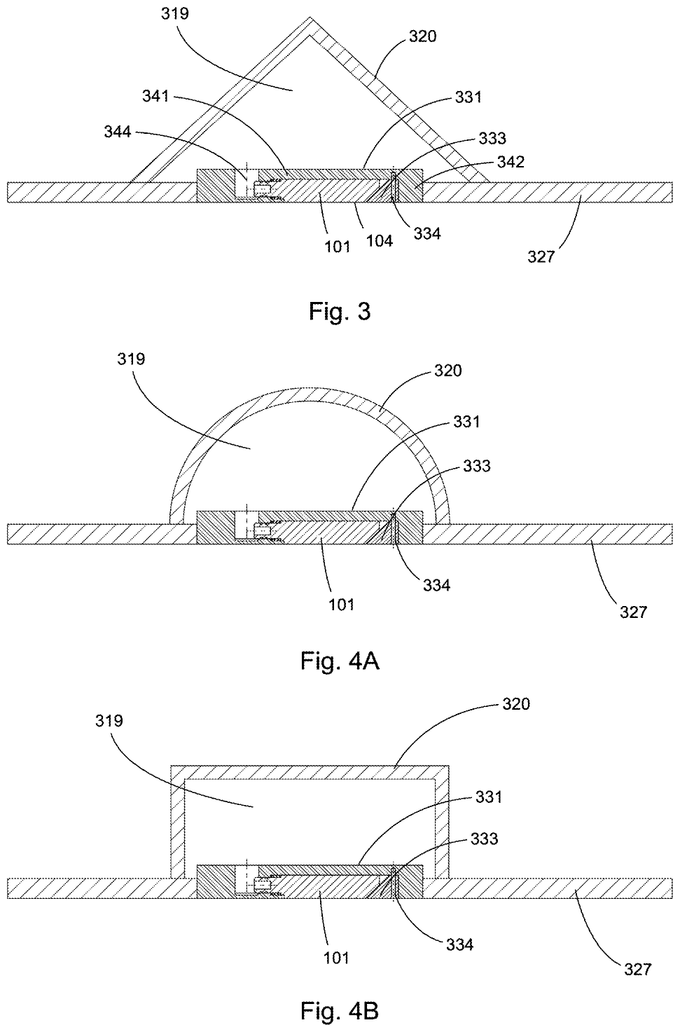

FIG. 3 shows a cross section of a hull of a vessel provided with oscillators of FIG. 1A;

FIG. 4A shows a cross section of an alternative embodiment of a hull of a vessel provided with oscillators of FIG. 1A;

FIG. 4B shows a cross section of a further alternative embodiment of a hull of a vessel provided with oscillators of FIG. 1A;

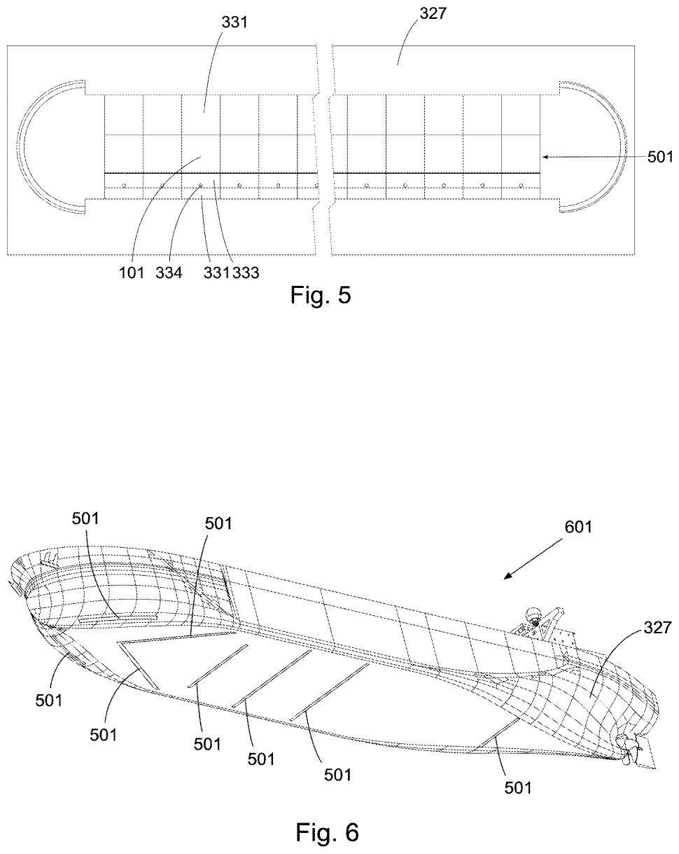

FIG. 5 shows a bottom view of the hull of the vessel provided with an array of the oscillators of FIG. 4; and

FIG. 6 shows perspective view of the vessel provided with a multitude of arrays of the oscillators.

The oscillator 101 as shown in FIGS. 1A and 1B is a traditional fluidic oscillator. The oscillator 101 may for instance be made of a suitable metal, plastic or composite material and is substantially a rectangular cuboid block shaped, having a bottom side, an upper side, a rear side, a front side, and two lateral sides. The height of the oscillator is substantially smaller than its width and length. The oscillator 101 comprises a air inlet formed in a protruding tube end 105 on its rear side. The air outlets at the bottom side of the oscillator are provided with perforated plates 104 with for instance fifty round holes of 1.7 mm diameter each. The front side of the oscillator is provided with a protrusion 102 having a sloping wall 103, which is arranged to be engaged by a locking element 333, as discussed below with reference to FIG. 3.

With reference to FIGS. 2A-D, the interior of the oscillator 101 is shown. An air inlet channel 206 leads away from the air inlet tube end 105. The air inlet channel 206 widens and diverges into two air outlet channels, more specifically a first outlet channel 207 and a second outlet channel 208 which lead to the two aforementioned air outlets 202, 203, more specifically to a first air outlet 202 and to a second air outlet 203, which are provided with said perforated plates 104.

The two outlet channels 207, 208 are separated by a splitter 209 with a concave nose 210.

The splitter 209 and the air inlet channel 206 and the outlet channels 207, 208 jointly constitute a bi-stable fluidic amplifier arranged to amplify control signals, whereby in this case the control signals are fed to the fluidic amplifier via a first control port 211 and a second control port 212.

From each of the air outlets 202, 203, a feedback channel 213 leads back to the control ports at the point where the air inlet channel 206 widens.

The oscillator 101 works as follows: A constant airflow is established at the air inlet 105 and through the air inlet channel 206. This airflow will either flow through the first outlet channel 207 or through the second outlet channel 208, but not through both at the same time. If undisturbed, the air will continue to flow this way because of the Coanda-effect, which enhances the tendency for a fluid to follow a curved surface. The transition from the air inlet channel 206 to each of the outlet channels 207, 208 is such a curved surface. The concave nose 210 of the splitter 209 helps to create an induced secondary airflow that further stabilises the airflow through that particular outlet channel 207, 208.

Most of the air flowing through this outlet channel 207, 208 will then exit at the corresponding air outlet 202, 203. However, this airflow also generates a pressure pulse which is sent back via the corresponding feedback channel 213 to the corresponding control port 211, 212, and which cause the airflow to switch to the other outlet channel 207, 208.

If left undisturbed, a stable airflow through the other outlet channel 207, 208 will now be established. However, also at the other air outlet 202, 203, a pressure wave is generated, which will be fed back via the feedback channel 213 to the corresponding control port 211, 212, so that the airflow switches to the other outlet channel 207, 208 again.

This way, a sequence of pressure control signals, in other words a pressure control wave, is established at both control ports 211, 212, every time switching the airflow from the first outlet channel 207 to the second outlet channel 208 and back, thereby generating two pulsating airflows, one in each of the outlet channels 207, 208, each pulsating with the same oscillation frequency and phase shifted by half a wave period.

These sequences of control signals are thereby amplified by the fluidic amplifier.

The oscillation frequency of the oscillator 101 is more or less fixed, depending on the exact design of the oscillator 101. A change in air pressure at the air inlet 105, resulting in a change in the total air flow rate through the oscillator 101, will influence the oscillation frequency to a relatively small degree, but the oscillation frequency can not be controlled independently of the air flow rate.

This oscillator 101 can be advantageously applied in the hull 327 of a vessel 601 according to the invention. This is illustrated in FIGS. 3 to 6. These figures show a vessel 601 which is provided with arrays 501 of oscillators 101. The vessel 601 may be a self propelled ship or may be intended to be towed by a tug.

With reference to FIGS. 3 and 5, an array 501 of oscillators 101 is mounted in the hull 327 of a vessel 601 by means of mounting means 331, 333, 334. An array of mounting blocks 331 is fixed in a slot shaped opening in the hull 327. Instead of an array of a multitude of mounting blocks 331 also one elongated mounting block 331 may be used which stretches along the entire length of the opening.

The mounting blocks 331 comprise a base plate 341 which covers the opening in the hull, a first end wall 342 and a second end wall 3313 which extend from, and perpendicular to, the outer ends of the base plate 341. The height of the end walls 342, 343 at their interior side is equal to the height of the oscillators 101.

The outer sides of the end walls 342, 343 are fixed to the edges of the hull 327, for instance by means of welding, in such a manner that the lower ends of the end walls 342, 343 are substantially flush with the lower surface of the hull 327.

The array of mounting blocks 331 (or a single elongated mounting block 331) thereby form a U-shaped gutter in which the oscillators 101 can be placed side by side to fill said gutter and form an array of oscillators 101 as shown in FIG. 5, and the lower surface of the oscillators 101 is substantially flush with the lower surface of the hull 327.

The first end wall 342 is provided with an L-shaped air inlet channel 344 for each air inlet tube end 105, wherein a first outer end of the air inlet channel 344 forms a horizontal opening in the interior side of the end wall 342, and the outer end of the air inlet channel 344 form an opening in the upper surface of the end wall 342.

Each tube end 105 forming the air inlet of the oscillators can be inserted in the first outer end of the L-shaped channel 344, thereby fixing the rear side of the oscillator to the mounting block 331 and the hull 327.

The front side of each oscillator 101 is fixed to the mounting block 331 by means of a locking element 334 which is arranged to engage the front side of the oscillator 101, in particular therefore the locking element is wedge shaped to engage the sloping wall 103 of the protrusion 102 at the front side of the oscillator 101 and to form a lower surface which is substantially flush to the lower surface of the hull 327. The locking element 334 is fixed to the base plate 3311 by means of screws 333.

An air channel 319 is formed on top of the array of oscillators, which air channel is in fluid communication with each of the air inlet channels 344 and thus with each of the air inlets tube ends 105 of the oscillators and the air outlets in the perforated plates 104, which are flush with the lower surface of the hull. As shown in FIG. 3 the air channel 319 is triangular in shape and formed by a gutter 320 comprised of two perpendicular walls, which is welded to the interior upper surface of the hull 327.

As shown in FIGS. 4A and 4B the air channel 319 may have alternative shapes, for instance formed by a gutter 320 in the form of a half-tube or a U-shaped gutter. The shape may be designed to achieve minimum flow resistance to the air supplied, while providing the required strength and stiffness to allow cost-effective integration with the vessel. The assembly represents a water-tight enclosure (cofferdam) meeting relevant certification rules to ensure the integrity of the hull 327. The assembly may feature a flow control and/or check-valve to control the air flow into the air channel 319 and to ensure water does not enter the ship through the oscillators 101. Baffles may be added in the air channel 19 to achieve a desired distribution of air to the oscillators 101 or ease drainage of the assembly in case of (water) flooding. The gutter may comprise inspection windows or removable covers to allow inspection of the air channel 319.

Compressed air is supplied by a compressor to the air channels 319. This compressed air is then distributed in the air channels 319 to the air inlet tube ends 105 of the oscillators 101, so that the oscillators 101 start to release a stream of bubbles from their air outlets 202, 203 through the perforated plates 104. This provides air lubrication between the hull 327 of the vessel 601 and the surrounding water, so that a reduction in drag is obtained.

The compressor is arranged to shut off as a safety measure if an alarm signal is detected.

As shown in FIG. 6, the arrays 501 of the oscillators 101 may be provided in any required configuration at any specific locations and in any specific orientations in the hull 327 of the vessel 601. The shown configuration with two slightly curved arrays at the bottom of the bow of the vessel 601, two arrays in a V-shaped point forward configuration near the front bottom surface of the hull 327, and a number of straight arrays extending in lateral direction and distributed along the length of the front part of the bottom surface of the hull 327, and a straight array extending in lateral direction near rear end of the bottom surface of the hull 327, appears to give good air lubrication results.

The invention has thus been described by means of preferred embodiments. It is to be understood, however, that this disclosure is merely illustrative. Various details of the structure and function were presented, but changes made therein, to the full extent extended by the general meaning of the terms in which the appended claims are expressed, are understood to be within the principle of the present invention. The description and drawings shall be used to interpret the claims. The claims should not be interpreted as meaning that the extent of the protection sought is to be understood as that defined by the strict, literal meaning of the wording used in the claims, the description and drawings being employed only for the purpose of resolving an ambiguity found in the claims. For the purpose of determining the extent of protection sought by the claims, due account shall be taken of any element which is equivalent to an element specified therein. An element is to be considered equivalent to an element specified in the claims at least if said element performs substantially the same function in substantially the same way to yield substantially the same result as the element specified in the claims.

1. A method for providing a hull of a vessel with bubble generators for reducing the drag of the hull, wherein said method comprises the following steps:
providing at least one elongated slot in the hull, said slot having a length extending in a lateral direction of the vessel and a width extending perpendicular thereto;
providing a multitude of bubble generator units, each of said multitude of bubble generator units having an inlet opening for supplying air and a bottom surface with at least one outlet opening for discharging air bubbles; and
mounting said multitude of bubble generator units in said slot in a side by side manner along the length of said slot such that said slot is filled and substantially closed off by said bubble generator units, and such that said inlet openings of said bubble generator units face the interior of the hull and the bottom surfaces with the outlet openings of said bubble generator units face the exterior of the hull.

2. The method according to claim 1, wherein the bubble generator units are mounted in said slots by a mount, said mount being fixed to the longitudinal edges of said slot along the entire length thereof, and wherein said bubble generator units are mounted to said mount in a releasable manner.

3. The method according to claim 2, wherein said mount comprises at least one mounting block, each mounting block comprising a base plate arranged to cover the width of the slot, and a first end wall and a second end wall which extend from the outer lateral ends of the base plate, wherein the end walls are fixed to the lateral edges of the slot, said at least one mounting block forming a substantially U-shaped channel in said slot in which the bubble generator units are mounted, such that the bottom surface of the bubble generator units are substantially flush with the exterior surface of the hull.

4. The method according to claim 2, wherein the interior surface of said base plate of said mounting block extends in a plane at a distance from the interior surface of the hull in the interior direction thereof.

5. The method according to claim 2, wherein the mount is provided with inlet channels corresponding and in communication with one of each inlet opening of the bubble generator units.

6. The method according to claim 5, wherein the inlet openings of the bubble generator units are formed by inlet tube ends which extend at a lateral side of the bubble generator units, the inlet tube ends being inserted in openings of the inlet channels which extend in corresponding side walls of the mounting blocks.

7. The method according to claim 2, wherein the bubble generator units are provided with a stepped or sloping protrusion at one side, and said mount comprises locking elements which are arranged to engage the protrusion, and provided with fasteners for fixing the locking elements to the base plate.

8. The method according to claim 1, further comprising the step of providing an air channel in the interior of said hull to each of said inlet openings for providing air to each of said bubble generator units.

9. The method according to claim 8, wherein said air channel is connected to a source of pressurised air.

10. The method according to claim 8, wherein said air channel is formed by a bent wall which covers the interior side of the slot and the bubble generator units therein, and wherein the lateral edges of the bent wall are connected to the interior surface of the hull.

11. The method according to claim 1, wherein the height of the bubble generator units is substantially smaller than the width of the slot.

12. The method according to claim 1, wherein the bubble generator units are fluidic oscillators for generating one or more pulsating air flows from a constant air flow.

13. A vessel with a hull provided with bubble generators for reducing the drag of the hull, wherein:
the hull is provided with at least one elongated slot, said slot having a length extending in a lateral direction of the vessel and a width extending perpendicular thereto;
wherein a multitude of bubble generator units is provided, each having an inlet opening for supplying air and a bottom surface with at least one outlet opening for discharging air bubbles; and
wherein said multitude of bubble generator units is provided in said slot in a side by side manner along the length of said slot such that said slot is filled and substantially closed off by said bubble generator units, and such that said inlet openings of said bubble generator units face the interior of the hull and the bottom surfaces with the outlet openings of said bubble generator units face the exterior of the hull.

14. The vessel according to claim 13, wherein the vessel is a self propelled ship or a vessel which is to be towed by another vessel.

15. The method according claim 3, wherein the interior surface of said base plate of said mounting block extends in a plane at a distance from the interior surface of the hull in the interior direction thereof.

16. The method according to claim 3, wherein the mount is provided with inlet channels corresponding and in communication with one of each inlet opening of the bubble generator units.

17. The method according to claim 4, wherein the mount is provided with inlet channels corresponding and in communication with one of each inlet opening of the bubble generator units.

18. The method according to claim 3, wherein the bubble generator units are provided with a stepped or sloping protrusion at one side, and said mount comprises locking elements arranged to engage the protrusion, and provided with fasteners for fixing the locking elements to the base plate.

19. The method according to claim 4, wherein the bubble generator units are provided with a stepped or sloping protrusion at one side, and said mount comprises locking elements arranged to engage the protrusion, and provided with fasteners for fixing the locking elements to the base plate.

20. The method according to claim 5, wherein the bubble generator units are provided with a stepped or sloping protrusion at one side, and said mount comprises locking elements arranged to engage the protrusion, and provided with fasteners for fixing the locking elements to the base plate.
